(19) United States
(12) Patent Application Publication
(10) Pub. No.: US 2026/0141634 A1
(43) Pub. Date: May 21, 2026

(54) APPARATUS AND METHOD FOR REAL-TIME WEB-BASED URBAN FLOOD

(71) Applicant: TSP XR, Seoul (KR)

(72) Inventors: Hoi Jun KIM, Seoul (KR); Chan Soo PARK, Seoul (KR); Jin Kyu KANG, Seoul (KR)

(21) Appl. No.: 19/060,961

(22) Filed: Feb. 24, 2025

(30) Foreign Application Priority Data
Nov. 19, 2024 (KR) 10-2024-0165097
Jan. 6, 2025 (KR) 10-2025-0001413

(51) Int. Cl. G06T 17/05; G01W 1/14; G06N 3/02

(52) U.S. Cl. CPC G06T 17/05; G01W 1/14; G06N 3/02

(57) ABSTRACT

The present disclosure discloses an apparatus and method for real-time web-based urban flood simulation. An apparatus for urban flood simulation according to the present disclosure includes a hardware processor and a storage unit connected to the processor to store a digital elevation model of a city, city design information and precipitation information, and at least one computer program configured to perform the method for urban flood simulation. The method for urban flood simulation includes (a) generating simulation zone information and water flow information using the digital elevation model of the city and the city design information, (b) generating flood-related information using the simulation zone information, the water flow information, and the precipitation information, and (c) visualizing and displaying the flood-related information.

### CROSS-REFERENCE TO RELATED APPLICATIONS

This application claims the priority of and priority to Korean Patent Application No. 10-2024-0165097 and 10-2025-0001413 filed on Nov. 19, 2024, and Jan. 6, 2025, respectively, in the Korean Intellectual Property Office, the entire disclosures of which are incorporated herein by reference.

### BACKGROUND

### Field

The present disclosure relates to an apparatus and method for urban flood simulation and method, and more specifically, to an apparatus and method for real-time web-based urban flood simulation.

### Description of the Related Art

The contents described in this section simply provide background information on the embodiments described in the present disclosure and do not necessarily constitute prior art.

Recently, urban areas have become more at risk of flood damage than before due to rapid climate change and increased precipitation. Existing flood simulation technologies are mainly optimized for flood prediction in large-scale urban environments and have limitations in flood prediction in small-scale cities and individual areas that require higher computational resources than in large-scale urban environments. For example, a method of performing flood simulation using computational fluid dynamics (CFD) requires a large amount of data and high-performance computer resources, and it takes a long time to derive results, so there is a limit to generating flood prediction information in real time. In addition, most flood simulation systems are dependent on local networks, making remote access difficult, and there is a limit to reflecting individual drainage facilities and topographical characteristics of a city.

### SUMMARY

An object of the present disclosure is to provide an apparatus and method for real-time web-based urban flood simulation.

The present disclosure is not limited to the problems mentioned above, and other problems not mentioned can be clearly understood by those skilled in the art from the description below.

In order to solve the above-described problems, an apparatus for urban flood simulation according to the present disclosure includes: a storage unit configured to store a digital elevation model of a city, city design information and precipitation information, and at least one computer program configured to perform a method for urban flood simulation; a simulation setting unit configured to generate simulation zone information and water flow information using the digital elevation model of the city and the city design information; a flood information generation unit configured to generate flood-related information using the simulation zone information, the water flow information, and the precipitation information; and a simulation output unit configured to visualize and display the flood-related information.

According to one embodiment of the present disclosure, the simulation setting unit may generate connection relationship information of elements constituting at least one drainage facility and location information of each drainage facility using the digital elevation model of the city and the city design information.

According to one embodiment of the present disclosure, the simulation setting unit may calculate a slope of a ground surface using an elevation value of the city extracted from the digital elevation model and generate information on a direction of water flow using the slope of the ground surface.

According to one embodiment of the present disclosure, the simulation setting unit may further extract an angle value of a pipe installed in at least one drainage facility from the city design information, and calculate a degree (Fᵢⱼ) of water flowing to an adjacent point using the following Mathematical Formula.

$${F}_{ij} = \frac{( {H}_{i} - {H}_{j} )}{{d}_{ij}} \times P \times cos ( θ ) \qquad [ Mathematical formula ]$$

Hᵢ: elevation at point i
Hⱼ: elevation at point j
dᵢⱼ: distance between two points
P: drainage characteristic coefficient
θ: pipe angle

According to one embodiment of the present disclosure, the simulation setting unit may calculate a discharge capacity (Dₒᵤₜ) of water in at least one drainage facility using the following Mathematical Formula using information on a pipe installed in at least one drainage facility from the city design information.

$${D}_{out} = {D}_{m} \times ( 1 - α \frac{{R}_{p}}{{W}_{p}} ) \qquad [ Mathematical Formula ]$$

Dₘ: basic discharge capacity of drainage facility
α: friction coefficient inside pipe
Rₚ: number of turns of pipe
Wₚ: width of pipe

According to one embodiment of the present disclosure, the flood information generation unit may generate information related to an expected flood pattern according to at least one precipitation pattern using the simulation zone information, the water flow information, and the precipitation information, and generate the flood-related information by further using the information related to the expected flood pattern.

According to one embodiment of the present disclosure, the simulation zone information may further include content related to watershed characteristics of the city, the content related to the watershed characteristics of the city may include at least one of an infiltration rate of water into soil, outflow of water from the ground surface per unit time, and a time taken for water to reach an outflow point, and the flood information generation unit may generate information related to the expected flood pattern by further using the content related to the watershed characteristics.

According to one embodiment of the present disclosure, the storage unit may further store an artificial neural network model that generates water outflow quantity and water discharge quantity information of at least one drainage facility using the simulation zone information, the water flow information, and the precipitation information as input values, and the flood information generation unit may input the simulation zone information, the water flow information, and the precipitation information to the artificial neural network model, and obtain the water outflow quantity and the water discharge quantity of at least one drainage facility from the artificial neural network model to generate the flood-related information.

According to one embodiment of the present disclosure, the artificial neural network model may include a Navier-Stokes equation expressed by the following Mathematical Formula as a portion of a loss function.

$$ρ ( \frac{δ u}{δ t} + ( u \cdot ∇ ) \vec{u} ) = - ∇ p + μ {∇}^{2} \vec{u} + f \qquad [ Mathematical Formula ]$$

ρ: fluid density
\vec{u}: fluid velocity vector
p: fluid pressure
μ: fluid viscosity coefficient
f: external force

According to one embodiment of the present disclosure, when an amount of water accumulated at at least one point included in the simulation zone exceeds a preset threshold, the simulation output unit may set the point as a flood risk zone and display a degree of flood risk in stages according to the amount of water accumulated.

In a method for urban flood simulation in an apparatus for urban flood simulation including a hardware processor and a storage unit connected to the processor and configured to store a digital elevation model of a city, city design information and precipitation information, and at least one computer program configured to perform the method for urban flood simulation, the method includes: (a) generating simulation zone information and water flow information using the digital elevation model of the city and the city design information; (b) generating flood-related information using the simulation zone information, the water flow information, and the precipitation information; and (c) visualizing and displaying the flood-related information.

According to one embodiment of the present disclosure, the (a) may include generating connection relationship information of elements constituting at least one drainage facility and location information of each drainage facility using the digital elevation model of the city and the city design information.

According to one embodiment of the present disclosure, the (a) may include calculating a slope of a ground surface using an elevation value of the city extracted from the digital elevation model and generating information on a direction of water flow using the slope of the ground surface.

According to one embodiment of the present disclosure, the (a) may further include extracting an angle value of a pipe installed in at least one drainage facility from the city design information, and calculating a degree (Fᵢⱼ) of water flowing to an adjacent point using the following Mathematical Formula.

$${F}_{ij} = \frac{( {H}_{i} - {H}_{j} )}{{d}_{ij}} \times P \times cos ( θ ) \qquad [ Mathematical formula ]$$

Hᵢ: elevation at point i
Hⱼ: elevation at point j
dᵢⱼ: distance between two points
P: drainage characteristic coefficient
θ: pipe angle

According to one embodiment of the present disclosure, the (a) may include calculating a discharge capacity (Dₒᵤₜ) of water in at least one drainage facility using the following Mathematical Formula using information on a pipe installed in at least one drainage facility from the city design information.

$${D}_{out} = {D}_{m} \times ( 1 - α \frac{{R}_{p}}{{W}_{p}} ) \qquad [ Mathematical Formula ]$$

Dₘ: basic discharge capacity of drainage facility
α: friction coefficient inside pipe
Rₚ: number of turns of pipe
Wₚ: width of pipe

According to one embodiment of the present disclosure, the (b) may be generating information related to an expected flood pattern according to at least one precipitation pattern using the simulation zone information, the water flow information, and the precipitation information, and generating the flood-related information by further using the information related to the expected flood pattern.

In this case, the simulation zone information may further include content related to watershed characteristics of the city, the content related to the watershed characteristics of the city may include at least one of an infiltration rate of water into soil, outflow of water from the ground surface per unit time, and a time taken for water to reach an outflow point, and the (b) may be generating information related to the expected flood pattern by further using the content related to the watershed characteristics.

According to one embodiment of the present disclosure, the storage unit may further store an artificial neural network model that generates water outflow quantity and water discharge quantity information of at least one drainage facility using the simulation zone information, the water flow information, and the precipitation information as input values, and the (b) may be inputting the simulation zone information, the water flow information, and the precipitation information to the artificial neural network model, and obtaining the water outflow quantity and the water discharge quantity of at least one drainage facility from the artificial neural network model to generate the flood-related information.

According to one embodiment of the present disclosure, the artificial neural network model may include a Navier-Stokes equation expressed by the following Mathematical Formula as a portion of a loss function.

$$ρ ( \frac{δ u}{δ t} + ( u \cdot ∇ ) \vec{u} ) = - ∇ p + μ {∇}^{2} \vec{u} + f \qquad [ Mathematical Formula ]$$

ρ: fluid density
\vec{u}: fluid velocity vector
p: fluid pressure
μ: fluid viscosity coefficient
f: external force

According to one embodiment of the present disclosure, the (c) may include, when an amount of water accumulated at at least one point included in the simulation zone exceeds a preset threshold, setting the point as a flood risk zone and visualizing a degree of flood risk in stages according to the amount of water accumulated.

A method for urban flood simulation according to the present disclosure may be implemented in the form of a computer program written to perform each step on a computer and recorded on a computer-readable recording medium.

Other specific details of the present disclosure are included in the detailed description and drawings.

According to one aspect of the present disclosure, the apparatus for urban flood simulation may run urban flood simulation in a web-based environment. A city manager may remotely access a web server through a terminal without being dependent on a local network and monitor water flow information, water accumulation information, and flood risk information according to precipitation in real time. The manager may monitor flood risk through the terminal anytime and anywhere when necessary. Through this, the city manager may immediately respond to flood or flooding situations caused by precipitation, and quickly identify zones risk to prepare immediate countermeasures. In addition, the apparatus for urban flood simulation may provide simulation results to the manager in 3D through metaverse linkage, thereby increasing the visual understanding of the manager and the speed of analysis more than before.

According to another aspect of the present disclosure, in order to solve the problem of insufficient reflection of detailed characteristics of small areas of the conventional method for urban flood simulation, the apparatus for urban flood simulation may reflect the characteristics of drainage facilities and topographic information of the city more precisely than the conventional method. Through this, the apparatus for urban flood simulation may generate flood information that may occur in a small city or a specific zone more quickly than the conventional method. While the conventional simulation method focuses on generating flood information of the entire large-scale city, the apparatus for urban flood simulation according to the present disclosure may generate the flood risk information of a specific area or zone more precisely than the conventional method by using detailed design data such as information (elevation of each point, topographic slope, or the like) included in the digital elevation model of the city, the city design information (width of drainage channel, angle of drainage channel, depth of manhole, width of pipe, rotation angle of pipe, or the like) and the precipitation information (precipitation, precipitation time, or the like). The apparatus for urban flood simulation may generate more accurate flood information by reflecting the special drainage patterns and watershed flows of individual areas by using such customized data. Accordingly, the apparatus for urban flood simulation may provide the city manager with flood risk information customized to a specific area better than before, and the city manager may establish flood response strategies customized to a specific area.

According to another aspect of the present disclosure, the apparatus for urban flood simulation may generate water flow information, accumulation information, and flood risk information more efficiently and accurately than the conventional method by using a physics informed neural network (PINN) model that integrates physical flow information of water. Unlike the fixed computational structure of the conventional urban flood simulation method, the apparatus for urban flood simulation may reduce data consumption more than the conventional method by using the artificial neural network model.

According to another aspect of the present disclosure, the apparatus for urban flood simulation may reduce the dependency of the city manager on high-end computing resources. In addition, the apparatus for urban flood simulation may provide the city manager with customized simulations and accurate urban flood prediction information tailored to various precipitation conditions and terrain characteristics.

The effects of the present disclosure are not limited to the effects mentioned above, and other effects not mentioned can be clearly understood by those skilled in the art from the description below.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 illustrates a relationship between an apparatus for urban flood simulation and a user terminal according to one embodiment of the present disclosure.

FIG. 2 illustrates a design diagram of a metaverse provided by an apparatus for web-based urban flood simulation according to one embodiment of the present disclosure.

FIG. 3 is a diagram illustrating an example of setting a precipitation.

FIG. 4 depicts diagrams illustrating an example of visualizing results of urban flood simulation according to the precipitation.

FIG. 5 is a block diagram of the apparatus for urban flood simulation according to one embodiment of the present disclosure.

FIG. 6 is a flowchart of a method for urban flood simulation according to one embodiment of the present disclosure.

FIG. 7 is a diagram illustrating the method for urban flood simulation.

FIG. 8 is a flowchart of a process of generating simulation zone information and water flow information in Step S10.

FIG. 9 is a flowchart of the process of generating flood-related information in Step S11.

FIG. 10 is a block diagram of an apparatus for urban flood simulation according to another embodiment of the present disclosure.

FIG. 11 illustrates a training process of a flow analysis model based on spatial information and physical conditions according to one embodiment of the present disclosure.

FIG. 12 illustrates a process of generating flood-related information using the flow analysis model according to one embodiment of the present disclosure.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

The advantages and features of the invention disclosed in the present disclosure, and the method of achieving them, will become clear with reference to the embodiments described in detail below together with the attached drawings. However, the present disclosure is not limited to the embodiments disclosed below, but can be implemented in various different forms, and the embodiments are provided only to make the disclosure of the present disclosure complete and to fully inform a person skilled in the art of the scope of the present disclosure, and the scope of rights of the present disclosure is defined only by the scope of the claims.

The terminology used herein is for the purpose of describing embodiments only and is not intended to limit the scope of the present disclosure. In the present disclosure, the singular also includes the plural unless specifically stated otherwise. The terms “comprise” and/or “comprising” as used herein do not exclude the presence or addition of one or more other components in addition to the components mentioned.

Throughout the specification, the same reference numerals refer to the same elements, and “and/or” includes each and every combination of the elements mentioned. Although “first”, “second”, and the like are used to describe various elements, these elements are not limited by these terms. These terms are only used to distinguish one element from another. Therefore, it is obvious that the first element mentioned below may also be the second element within the technical concept of the present disclosure.

Unless otherwise defined, all terms (including technical and scientific terms) used in the present disclosure may be used in a meaning that can be commonly understood by a person skilled in the art to which the present disclosure pertains. In addition, terms defined in commonly used dictionaries are not to be idealized or overly interpreted unless explicitly specifically defined.

An artificial neural network (ANN) is an artificial intelligence implemented by connecting artificial neurons that mathematically model the neurons that make up the human brain.

In the present disclosure, an “artificial neural network model” may be composed of a set of interconnected computational units, which may generally be referred to as nodes. These nodes may also be referred to as neurons. A neural network includes at least one or more nodes. The nodes (or neurons) constituting the neural networks may be interconnected by one or more links.

In the neural network, one or more nodes connected through links may form a relationship between input nodes and output nodes relative to each other. The concept of input nodes and output nodes is relative, and any node in an output node relationship to one node may be in an input node relationship with another node, and vice versa. As described above, an input node-to-output node relationship may be created based on links. One or more output nodes may be connected to one input node through links, and vice versa.

The initial input node may mean one or more nodes in the neural network to which data is directly input without going through links in a relationship with other nodes. Alternatively, in the neural network, in a relationship between nodes based on links, the initial input node may mean nodes that do not have other input nodes connected by links. Similarly, a final output node may mean one or more nodes that do not have output nodes in a relationship with other nodes in a neural network. In addition, a hidden node may mean nodes that constitute a neural network other than the initial input node and the final output node.

In the present disclosure, “inputting” data into the artificial neural network model means that a value is input to the initial input node. In the present disclosure, “obtaining a value,” “outputting data,” “obtaining information,” and the like from an artificial neural network mean that some data is output from the final output node.

A deep neural network (DNN) may mean a neural network that includes multiple hidden layers in addition to an input layer and an output layer. The deep neural network may include a convolutional neural network (CNN), a recurrent neural network (RNN), an auto encoder, a generative adversarial network (GAN), a restricted Boltzmann machine (RBM), a deep belief network (DBN), a Q network, a U network, a Siamese network, a generative adversarial network (GAN), and the like. The description of the above-described deep neural network is only an example, and the present disclosure is not limited thereto.

The neural network may be trained in at least one method of supervised learning, unsupervised learning, semi-supervised learning, or reinforcement learning. The learning of the neural network may be a process of applying knowledge to the neural network to perform a specific operation by the neural network.

A neural network may be trained in the direction of minimizing the error of the output. In the learning of a neural network, training data is repeatedly input into the neural network, the output of the neural network for the training data and the target error are calculated, and the error of the neural network is backpropagated from the output layer of the neural network to the input layer in the direction of reducing the error, thereby updating the weights of each node of the neural network. In the case of supervised learning, training data in which the correct answer is labeled for each training data is used (that is, labeled training data), and in the case of unsupervised learning, the correct answer may not be labeled for each training data. That is, for example, in the case of supervised learning for data classification, the training data may be data in which categories are labeled for each training data. The labeled training data is input into the neural network, and the error may be calculated by comparing the output (category) of the neural network with the label of the training data. As another example, in the case of unsupervised learning for data classification, the error may be calculated by comparing the input training data with the output of the neural network. The calculated error may be backpropagated in the backward direction (that is, from the output layer to the input layer) in the neural network, and the connection weights of each node in each layer of the neural network may be updated according to the backpropagation. The amount of change in the connection weights of each node to be updated may be determined according to the learning rate. The calculation of the neural network for the input data and the backpropagation of the error may constitute a learning cycle (epoch). The learning rate may be applied differently depending on the number of repetitions of the learning cycle of the neural network. For example, a high learning rate may be used in the early stage of learning of the neural network so that the neural network may quickly obtain a certain level of performance, thereby increasing efficiency, and a low learning rate may be used in the later stage of learning to increase accuracy.

In the present disclosure, the “learning” of the artificial neural network model means that the neural network updates the connection weights of each node so that the output error is minimized, and the “learning” according to the present disclosure is not limited by a specific learning method.

In the present disclosure, a “processor” may be composed of one or more cores, and may include a processor for data analysis and deep learning, such as a central processing unit (CPU), a general purpose graphics processing unit (GPGPU), and a tensor processing unit (TPU) of a computing device. The processor may read a computer program stored in a memory and perform data processing for machine learning according to one embodiment of the present disclosure. According to one embodiment of the present disclosure, the processor may perform operations for learning a neural network. The processor may perform calculations for learning a neural network, such as processing input data for learning in deep learning (DL), extracting features from input data, calculating errors, and updating weights of a neural network using backpropagation. At least one of the CPU, GPGPU, and TPU of the processor may process learning of a network function. For example, the CPU and GPGPU may together process learning of a network function and classification of data using a network function. In addition, in one embodiment of the present disclosure, the processors of multiple computing devices may be used together to process learning of network functions and classification of data using network functions. In addition, the computer program executed on the computing device according to one embodiment of the present disclosure may be a CPU, GPGPU, or TPU executable program.

Hereinafter, the embodiment of the present disclosure will be described in detail with reference to the attached drawings.

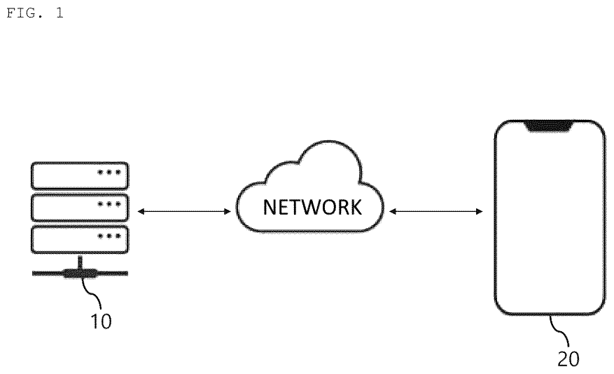

FIG. 1 illustrates a relationship between an apparatus for urban flood simulation and a user terminal according to one embodiment of the present disclosure.

Referring to FIG. 1, the apparatus 10 for urban flood simulation may be a server device that provides a web-based urban flood simulation. A terminal 20 may access the apparatus 10 for urban flood simulation through an external network. A user may check urban flood simulation results provided from the apparatus 10 for urban flood simulation using a web application installed on the terminal 20. The terminal 20 corresponds to a computer, a laptop, a smartphone, a tablet computer, and the like, and is not limited by a specific device.

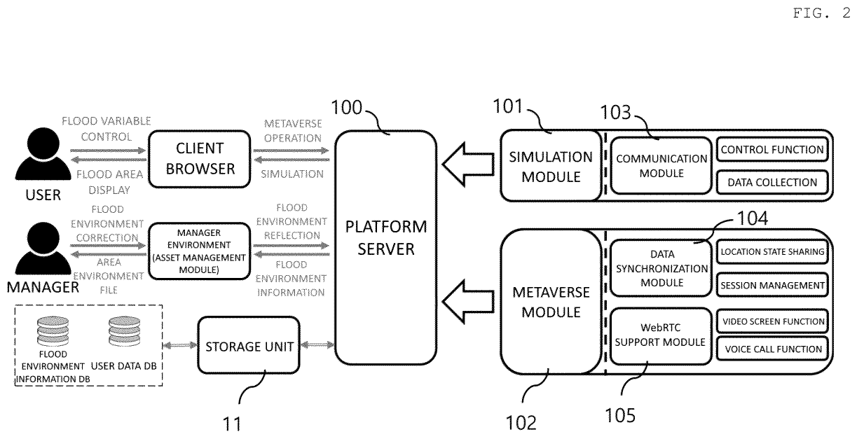

FIG. 2 illustrates a design diagram of a metaverse provided by an apparatus for web-based urban flood simulation according to one embodiment of the present disclosure.

Referring to FIG. 2, the apparatus 10 for urban flood simulation may provide a metaverse platform server 100 to a user (city manager). The user may access the platform server 100 using a web application installed on a terminal 20. The user may input variable values for flood simulation and input operation values for interaction with a metaverse environment through the terminal 20.

The apparatus 10 for urban flood simulation may transmit the urban flood simulation results to the terminal 20. The user may check the simulation results expressed in 3D within the metaverse through a web application installed on the terminal 20.

A manager (server manager) may input flood environment information according to environmental changes in a specific city into the apparatus 10 for urban flood simulation through an asset management module. The apparatus 10 for urban flood simulation may update flood environment data based on the data input by the manager. The apparatus 10 for urban flood simulation may provide the updated flood environment information to the manager.

The user's data and flood environment information may be stored in a storage unit 11. Alternatively, the user's data and flood environment information may be stored in a separate database server device.

The apparatus 10 for urban flood simulation may execute the urban flood simulation based on input data and visualize and display the simulation results. The apparatus 10 for urban flood simulation may include a simulation module 101 and a metaverse module 102.

The simulation module 101 may include a communication module 103 for communicating with the terminal 20 through a network. The communication module 103 may communicate with the terminal 20 using an IoT (Internet of Things) communication protocol, which is an example and is not limited by the communication protocol. The simulation module 101 may control the urban flood simulation and collect data for the simulation from the terminal 20 and/or an external data server.

The metaverse module 102 may include a data synchronization module 104 and a WebRTC support module 105. The data synchronization module 104 may synchronize data between multiple users and/or multiple devices. The data synchronization module 104 may synchronize locations and states of multiple users and track activities of multiple users to manage sessions. In addition, the WebRTC support module 105 may support video screen sharing and voice calls between multiple users based on the web using WebRTC (web real-time communication).

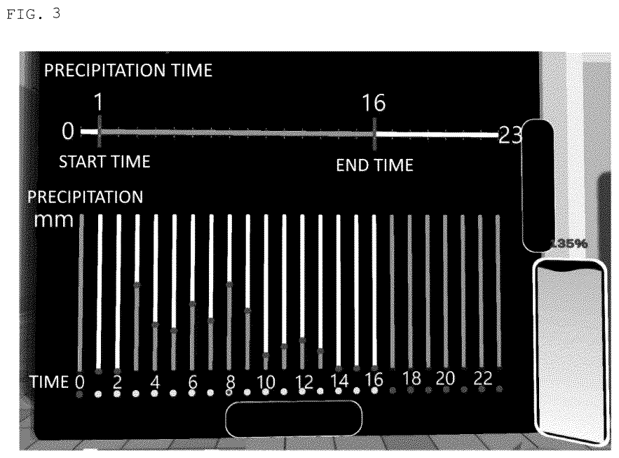

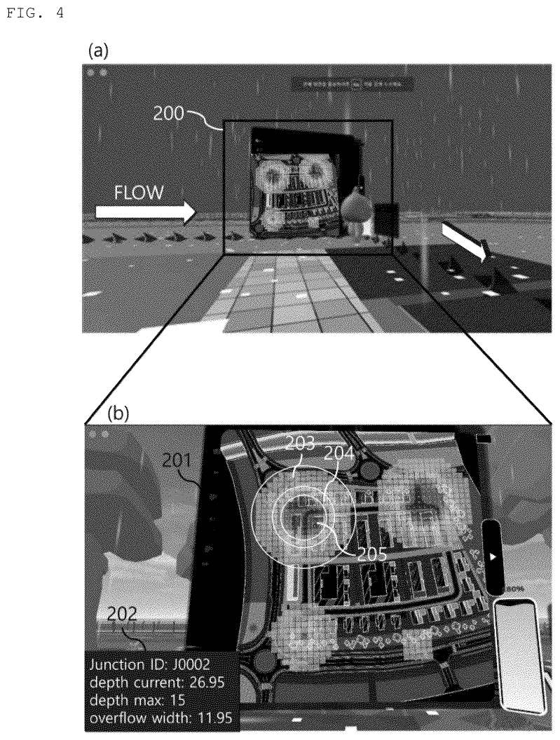

FIG. 3 is a diagram illustrating an example of setting a precipitation, and FIG. 4 depicts diagrams illustrating an example of visualizing the results of urban flood simulation according to the precipitation.

Referring to FIG. 3, the user may set precipitation time, precipitation over time, or the like for urban flood simulation using the terminal 20. Alternatively, the apparatus 10 for urban flood simulation may set precipitation time, precipitation over time, or the like for simulation based on precipitation information provided by the Korea Meteorological Administration.

Referring to FIG. 4, the apparatus 10 for urban flood simulation may perform urban flood simulation based on the set precipitation. The apparatus 10 for urban flood simulation may visually implement the simulation result as illustrated in (a) in FIG. 4. A simulation result screen 200 may be visualized as illustrated in (b) in FIG. 4. In the simulation result screens 200 and 201, a flood risk zone may be displayed together with a map image of a specific zone of the city. In addition, in the simulation result, the content related to location information (Junction ID), water accumulation information (depth current), maximum depth information (depth max), and flood information (overflow width) of the flood risk zone may be displayed on a dashboard 202.

Below, the apparatus for urban flood simulation according to the present disclosure will be described in more detail.

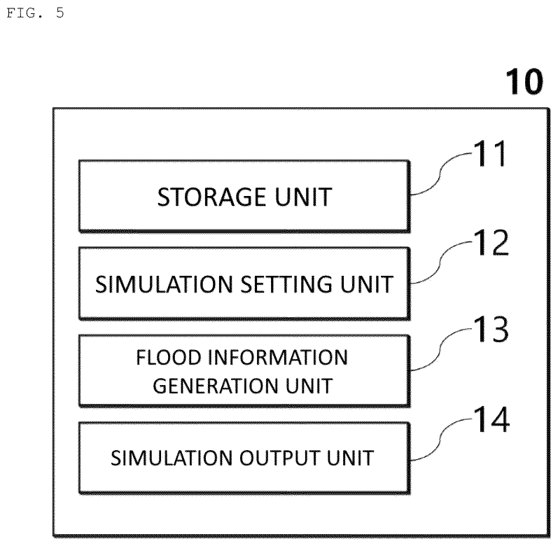

FIG. 5 is a block diagram of the apparatus for urban flood simulation according to one embodiment of the present disclosure.

Referring to FIG. 5, the apparatus 10 for urban flood simulation according to one embodiment of the present disclosure may include the storage unit 11, a simulation setting unit 12, a flood information generation unit 13, and a simulation output unit 14. The simulation setting unit 12 may include the simulation module 101. The simulation output unit 14 may include the metaverse module 102.

The simulation setting unit 12, the flood information generation unit 13, the simulation output unit 14, and a learning unit 15 to be described below may be implemented as a hardware processor. The simulation setting unit 12, the flood information generation unit 13, the simulation output unit 14, and the learning unit 15 may include a processor, an application-specific integrated circuit (ASIC), another chipset, a logic circuit, a register, a communication modem, a data processing device, or the like known in the technical field to which the present disclosure belongs to execute calculations and various control logics. In addition, when the above-described control logic is implemented as software, the simulation setting unit 12, the flood information generation unit 13, the simulation output unit 14, and the learning unit 15 may be implemented as a set of program modules. In this case, the program modules may be stored in the memory device and executed by the processor.

The storage unit 11 may store at least one computer program configured to perform the method for urban flood simulation. The processor may execute at least one computer program configured to perform the method for urban flood simulation to perform the urban flood simulation and visually implement the simulation results. The processor may provide the urban flood simulation to the user through the web.

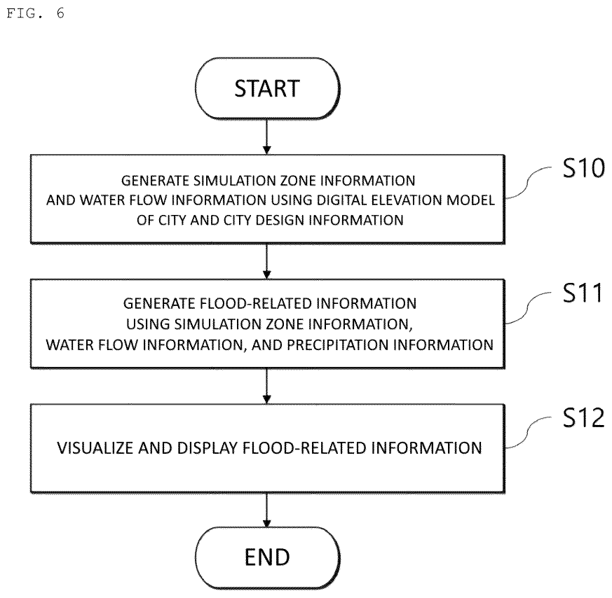

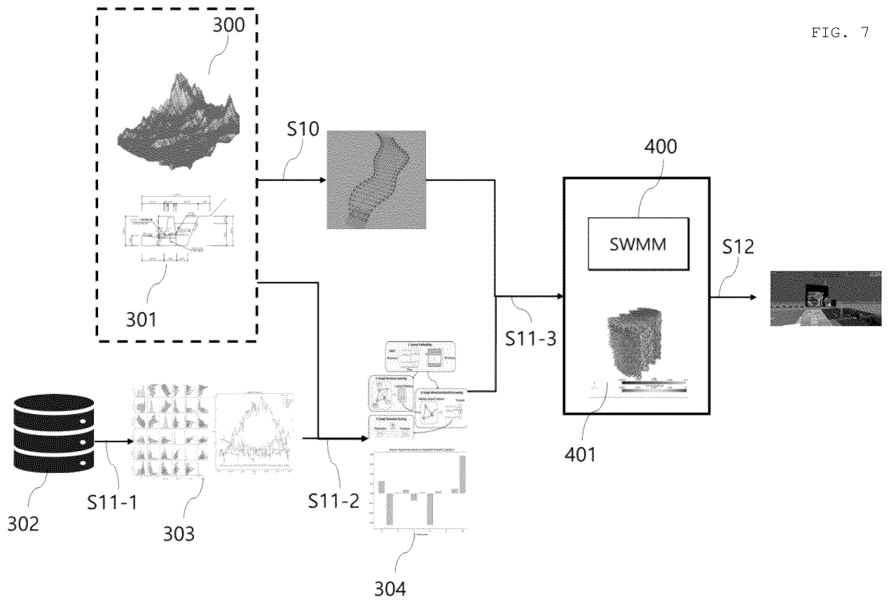

FIG. 6 is a flowchart of a method for urban flood simulation according to one embodiment of the present disclosure, and FIG. 7 is a diagram illustrating the method for urban flood simulation.

Referring to FIG. 6 and FIG. 7, in Step S10, the simulation setting unit 12 may generate simulation zone information using a digital elevation model (DEM) 300 of the city and city design information 301. The simulation setting unit 12 may implement a simulation zone in 3D using the generated simulation zone information.

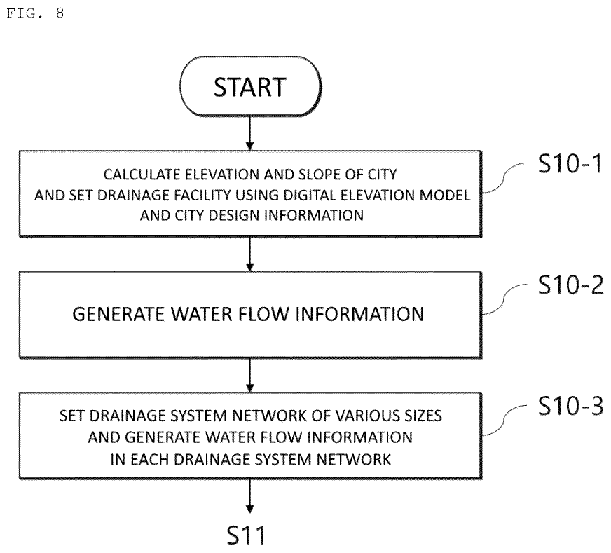

FIG. 8 is a flowchart of a process for generating the simulation zone information and water flow information in Step S10.

Referring to FIG. 8, the simulation setting unit 12 may generate the simulation zone information based on the digital elevation model of the city and the city design information to build a simulation environment.

According to one embodiment of the present disclosure, the storage unit 11 may store the digital elevation model 300 of the city and city design information 301 in advance. The digital elevation model 300 may be a digital elevation model provided by the National Geographic Information Institute of the Ministry of Land, Infrastructure and Transport. The city design information 301 may include a design drawing of the city and/or a design drawing of at least one drainage facility installed in the city. The city drainage facility may include components such as a manhole, sewer, and pipe installed to allow water to flow into and out of a river or stream.

In addition, the city design information 301 may include content related to land use plan maps, land use status maps, land information, sewage treatment facility status, urban planning facility status, watershed classification information, watershed characteristic-related information, flood management zone information, and geological structure information provided by the public data portal.

The simulation setting unit 12 may receive the digital elevation model 300 and city design information 301 from a manager's terminal and store them in the storage unit 11. Alternatively, the processor may obtain the digital elevation model 300 and city design information 301 using an open application programming interface (API) provided by the public data portal.

The simulation setting unit 12 may generate 3D modeling information of the city using the digital elevation model 300 and the city design information 301, and since this is a technology widely known to those skilled in the art, a detailed description thereof will be omitted. In this case, the simulation setting unit 12 may generate connection relationship information of components (manhole, sewer, pipe, or the like) constituting at least one drainage facility using the digital elevation model 300 and the city design information 301, and may generate location information of each drainage facility. The simulation setting unit 12 may generate simulation zone information including the connection relationship information, location information of each drainage facility, and drainage zone information of each drainage facility.

In Step S10-1, the simulation setting unit 12 may extract the latitude, longitude, and elevation values of the city from the digital elevation model 300. In addition, the simulation setting unit 12 may calculate the slope of the ground surface of the city from the digital elevation model 300. The slope of the ground surface may be used to set the direction of water flow in the simulation environment.

The simulation setting unit 12 may calculate the slope of the ground surface by calculating an elevation change rate around each cell in the digital elevation model 300. The simulation setting unit 12 may calculate an elevation change rate in an east-west direction (x-axis direction) and an elevation change rate in a south-north direction (y-axis direction) using [Mathematical Formula 1] and [Mathematical Formula 2], respectively.

$${G}_{x} = \frac{{Z}_{i + 1 , j} - {Z}_{i - 1 , j}}{2 \cdot Δ x} \qquad [ Mathematical Formula 1 ]$$

Z_{i,j}: elevation value at point (i, j) in digital elevation model
Δx: x-axis distance between two points

$${G}_{y} = \frac{{Z}_{i , j + 1} - {Z}_{i , j - 1}}{2 \cdot Δ y} \qquad [ Mathematical Formula 2 ]$$

Z_{i,j}: elevation value at point (i, j) in digital elevation model
Δy: Y-axis distance between two points

After this, the simulation setting unit 12 may calculate the slope of the ground surface using the elevation change rate in the x-axis direction and the elevation change rate in the y-axis direction. The simulation setting unit 12 may calculate the slope of the ground surface using [Mathematical Formula 3].

$$Slope = {tan}^{- 1} ( \sqrt{{G}_{x}^{2} - {G}_{y}^{2}} ) \qquad [ Mathematical Formula 3 ]$$

In addition, the simulation setting unit 12 may generate information related to at least one drainage facility using the city design information 301. The simulation setting unit 12 may extract connection information between a manhole and a sewer using the city design information. In addition, the simulation setting unit 12 may extract information on the thickness, length, diameter, and angle of inclination from a horizontal plane of each of a plurality of pipes included in a sewer system from the city design information 301. In addition, the simulation setting unit 12 may extract information on a connection relationship between the plurality of pipes, whether the direction of water flow is changed due to a pipe elbow, or the like. The simulation setting unit 12 may generate network information of the drainage system, which is connection relationship information of components (manhole, sewer, pipe, or the like) of the city drainage system using the information extracted from the city design information. The simulation setting unit 12 may extract the information from the city design information using an image analysis algorithm and/or an optical character recognition algorithm, or the like. In addition, the simulation setting unit 12 may obtain the information by inputting the city design information into a pre-learned artificial neural network model.

The simulation setting unit 12 may generate location information for each drainage facility in a three-dimensional space by integrating information obtained using the digital elevation model 300 and city design information 301, thereby generating 3D modeling information for the drainage facilities of the city.

In Step S10-2, the simulation setting unit 12 may generate water flow information including contents related to the direction of water flow, water flow speed, water discharge capacity, or the like in each drainage facility by using information obtained from the digital elevation model 300 and the city design information 301. Based on the water flow information, the simulation setting unit 12 may generate information on the direction of water flow in the overall network of the drainage system of the city, the location of the outlet through which water flows out of the drainage facility into a stream or river, or the like.

The process in which the simulation setting unit 12 obtains the elevation value and slope of the city from the digital elevation model may be essential for determining the drainage possibility of each drainage facility. For example, in the case of a point with a relatively high elevation, water may easily flow out, while in the case of a point with a relatively low elevation, water may be more likely to accumulate. The simulation setting unit 12 may set the flow path of water according to the elevation value and slope of the city.

At the beginning stage of the urban flood simulation, precipitation R is distributed to each point in the simulation zone, and the increased precipitation over time may accumulate at each point. The simulation setting unit 12 may calculate a degree to which water flows from a specific point (or a specific drainage facility) in the simulation zone to an adjacent point (or an adjacent drainage facility) by reflecting the slope of the ground surface and the characteristics of the drainage facility. The simulation setting unit 12 may calculate the degree to which water flows to an adjacent point using the following [Mathematical Formula 4].

$${F}_{ij} = \frac{( {H}_{i} - {H}_{j} )}{{d}_{ij}} \times P \times cos ( θ ) \qquad [ Mathematical Formula 4 ]$$

Hᵢ: elevation at point i
Hⱼ: elevation at point j
dᵢⱼ: distance between two points
P: drainage characteristic coefficient
θ: pipe angle

The θ is the pipe angle, which may reflect the water flow resistance. In this case, the pipe angle may mean the angle at which the pipe is tilted with respect to a horizontal plane. The pipe angle may be a value extracted from the design drawing of the drainage facility.

The drainage characteristic coefficient may be calculated based on the material, diameter, length, viscosity of the fluid, or the like of the pipe.

The simulation setting unit 12 may set the direction of water movement so that water flows from a point with a relatively high elevation to a point with a low elevation. By setting the direction of water movement, the simulation setting unit 12 may generate information on an inflow path of water at a specific point.

The simulation setting unit 12 may calculate the amount of water discharged at each point of the simulation zone in real time, and identify the point where water flow is likely to occur.

The simulation setting unit 12 may dynamically calculate the water discharge capacity Dₒᵤₜ by reflecting the characteristics (pipe diameter, length, angle, direction change, or the like) of each drainage facility. The water discharge capacity changes according to the design of the drainage facility and real-time precipitation conditions, and may be adjusted according to the resistance factor and capacity of the pipe. The simulation setting unit 12 may calculate the discharge capacity using the following [Mathematical Formula 5].

$${D}_{out} = {D}_{m} \times ( 1 - α \frac{{R}_{p}}{{W}_{p}} ) \qquad [ Mathematical Formula 5 ]$$

Dₘ: basic discharge capacity of drainage facility
α: friction coefficient inside pipe
Rₚ: number of turns of pipe
Wₚ: width of pipe

The number of turns of the pipe may refer to the number of times the direction of water flow changes due to a pipe elbow, a U-shaped pipe, a tee pipe, or the like.

The simulation setting unit 12 dynamically adjusts the amount of water that the pipe can discharge using [Mathematical Formula 5], and the discharge capacity may be relatively smaller as the number of turns increases or the width of the pipe narrows. Through this, the simulation setting unit 12 may calculate the amount of water discharged according to the characteristics of the actual drainage facility.

The flood information generation unit 13 may generate overload risk information of the drainage facility using the inflow of water due to precipitation and the amount of water discharged from the drainage facility. In particular, the flood information generation unit 13 may identify the limit that each drainage facility may handle when the precipitation increases rapidly.

In Step S10-3, the simulation setting unit 12 may set the flow direction, speed, and outflow of water or the like in the plurality of drainage facilities using the water flow information. Based on this, the simulation setting unit 12 may set contents related to the water flow in the network of the entire city drainage system. In addition, the simulation setting unit 12 may use the water flow information to set contents related to the water flow in small-scale units such as a sewer connected to one manhole and another adjacent manhole, contents related to the water flow in medium-scale units such as a sewer connecting a plurality of manholes included in one block of the city, and contents related to the water flow in large-scale units such as the network of the entire city drainage system. Through this, the simulation setting unit 12 may efficiently generate results of the urban flood simulation in small-scale, medium-scale, and large-scale units. In addition, the simulation setting unit 12 may precisely analyze the influence of the characteristics of the drainage facilities installed in each unit in small-scale, medium-scale, and large-scale units on the water flow, thereby increasing the accuracy of the urban flood simulation.

Referring again to FIGS. 6 and 7, in Step S11, the flood information generation unit 13 may generate flood-related information according to precipitation in the simulation zone using the simulation zone information, water flow information, and precipitation information. The storage unit 11 may have the storm water management model (SWMM) software provided by the U.S. Environmental Protection Agency installed in advance. The flood information generation unit 13 may generate the flood-related information by executing the urban flood simulation using a SWMM 400. The flood-related information may mean a simulation result produced through the SWMM 400. The flood-related information may include content related to water flow, water accumulation, and flood risk in the network of the drainage system.

Since conducting the urban flood simulation using the SWMM 400 is a widely known technique among those skilled in the art, a detailed description thereof is omitted.

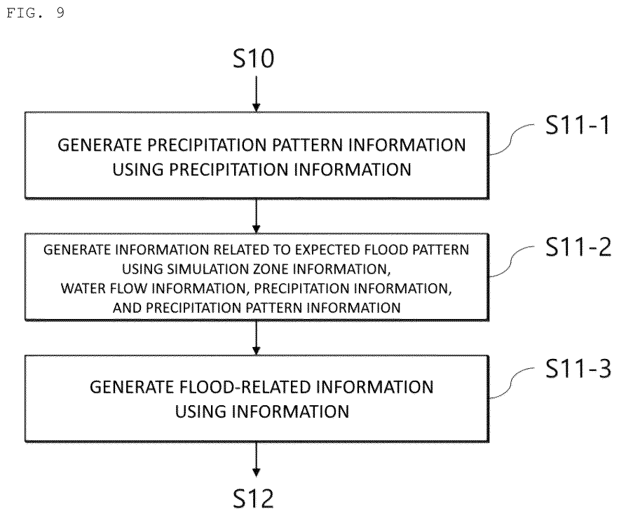

FIG. 9 is a flowchart of the process of generating the flood-related information in Step S11.

Referring to FIG. 9, in Step S11-1, the flood information generation unit 13 may set a precipitation pattern from the precipitation information of the city. The precipitation information 302 of the city may be stored in advance in the storage unit 11. The precipitation information for each city provided by the Korea Meteorological Administration may be used as the precipitation information. The precipitation information 302 may include content related to current hourly precipitation, expected precipitation time, expected precipitation, expected cumulative precipitation, past precipitation, or the like, but is not limited thereto. The flood information generation unit 13 may retrieve the precipitation information of an actual city in real time using the open API of the Korea Meteorological Administration. Alternatively, the precipitation information may be input in real time from the terminal 20.

The flood information generation unit 13 may analyze the precipitation information 302 to generate at least one precipitation pattern 303. The flood information generation unit 13 may set the hourly precipitation using the precipitation information to generate the precipitation pattern 303. In addition, the flood information generation unit 13 may set the total accumulated precipitation and set a time interval in which the precipitation is concentrated to generate the precipitation pattern 303. The flood information generation unit 13 may generate the precipitation pattern in various ways using the precipitation information.

Alternatively, the user may directly input the precipitation pattern 303 through the terminal 20.

In Step S11-2, the flood information generation unit 13 may generate information 304 related to at least one expected flood pattern that may occur in the city using the simulation zone information, the water flow information, the precipitation information, and the precipitation pattern.

For example, the flood information generation unit 13 may generate the precipitation pattern 303 by setting the hourly precipitation using the precipitation information 302. Thereafter, the flood information generation unit 13 may generate information 304 related to the expected flood pattern based on the simulation zone information, the water flow information, and the generated precipitation pattern. The information 304 related to the expected flood pattern may include content related to the area that is flooded first during the precipitation, the area that is flooded last, the manhole that is saturated first, or the like. In addition, the information 304 related to the expected flood pattern may include content related to the area from which water flows out first when precipitation weakens. The flood information generation unit 13 may compare the amount of water discharged from a drainage facility according to the water flow information with the amount of water inflow due to precipitation to calculate the water accumulation rate at each point, and generate the information 304 related to the expected flood pattern.

According to one embodiment of the present disclosure, the simulation zone information may include content related to watershed characteristics of the city. The flood information generation unit 13 may extract content related to watershed characteristics from the city design information.

The contents to the related above watershed characteristics may include contents related to the shape, area, elevation, slope, slope direction, flow rate of the river, types of soil and geology, or the like of the watershed. The flood information generation unit 13 may generate hydrological characteristic information for the watershed of the city by utilizing the contents related to the watershed characteristics.

The flood information generation unit 13 may further utilize the contents related to the watershed characteristics to generate information 304 related to the expected flood pattern.

The flood information generation unit 13 may calculate the inflow and outflow of water at each point using the simulation zone information, the water flow information, the precipitation information, and the contents related to the watershed characteristics. The inflow and outflow of water calculated using the contents related to the watershed characteristics may mean the inflow and outflow of water at the ground surface.

The flood information generation unit 13 may calculate the water inflow using the precipitation information and the contents related to the watershed characteristics. The flood information generation unit 13 may calculate the infiltration rate of water over time based on the contents related to soil and geology in contents related the to the watershed characteristics. The infiltration rate of water may be calculated using the Horton infiltration model defined by the following [Mathematical Formula 6].

$$f ( t ) = {f}_{c} + ( {f}_{0} - {f}_{c} ) {e}^{- kt} \qquad [ Mathematical Formula 6 ]$$

f₀: initial infiltration rate
f_{c}: final infiltration rate
k: infiltration rate reduction factor

Since calculating the amount of water infiltrated into the soil using the Horton infiltration model is a widely known technique among those skilled in the art, a detailed description thereof is omitted.

The flood information generation unit 13 may calculate the amount of water infiltrated into the soil and the amount of evaporation loss. Based on this, the flood information generation unit 13 may calculate the final inflow using the hourly precipitation, the amount of water flowing into the point from an adjacent point, the amount of water infiltrated into the soil, and the amount of water lost through evaporation.

The flood information generation unit 13 may calculate the final inflow by subtracting the amount of water infiltrated into the soil and the amount of water lost through evaporation from the hourly precipitation and the amount of water flowing into the point from an adjacent point.

In addition, the flood information generation unit 13 may calculate the water outflow at each point using the contents related to the watershed characteristics mentioned above. The flood information generation unit 13 may calculate the outflow per unit time using the following [Mathematical Formula 7].

$${Q}_{outflow} = C \cdot {P}_{effective} \cdot A \qquad [ Mathematical Formula 7 ]$$

C: runoff coefficient (city center: 0.7)
P_{effective}: effective precipitation
A: area of point

In addition, the flood information generation unit 13 may calculate the water discharge time using the following [Mathematical Formula 8]. The water discharge time may mean the time taken for water to flow from each point to an adjacent point.

$${T}_{C} = \frac{L}{V} \qquad [ Mathematical Formula 8 ]$$

T_{C}: water outflow time
L: outflow path length
V: flow rate

The flood information generation unit 13 may calculate the final outflow at the ground surface using the water inflow, water outflow, and water outflow time at each point. The flood information generation unit 13 may generate the information 304 related to the expected flood pattern by further using the water inflow and water outflow at the ground surface calculated using the content related to the watershed characteristics.

In addition, the storage unit 11 may further store an artificial neural network model (hereinafter referred to as a “pattern analysis model”) trained to generate the information related to the expected flood pattern using the simulation zone information, the water flow information, and the precipitation information as input values. The flood information generation unit 13 may obtain information related to the expected flood pattern by inputting the simulation zone information, the water flow information, and the precipitation information into the pattern analysis model.

In Step S11-3, the flood information generation unit 13 may generate the flood-related information using the simulation zone information, the water flow information, the information related to at least one expected flood pattern, and the precipitation information used for the urban flood simulation.

Afterwards, the flood information generation unit 13 may generate the flood-related information using the simulation zone information, the water flow information, the information related to at least one expected flood pattern, and the precipitation information used for the urban flood simulation.

The apparatus 10 for urban flood simulation may increase the reliability of the urban flood simulation by reflecting realistic weather conditions. The flood information generation unit 13 may set a precipitation pattern suitable for an area where heavy rain is expected. Through this, the apparatus 10 for urban flood simulation may preemptively identify an area with a high flood risk under specific precipitation conditions. Unlike the existing simple precipitation input, the flood information generation unit 13 may generate water flow information between the points by considering the size and shape of the watershed and the inflow path. Through this, the users may check the water accumulation and drainage amount in a specific zone and respond to flooding early.

The flood information generation unit 13 may build an urban flood simulation environment by inputting the simulation zone information, the water flow information, the precipitation information, the precipitation pattern information, and the expected flood pattern information into the SWMM 400. The flood information generation unit 13 processes the precipitation information inputted using the SWMM 400 in real time and may automatically calculate the simulation whenever the data is updated. The precipitation at each point may change according to the time step. The flood information generation unit 13 may generate the flood-related information according to the precipitation that changes according to the capacity and slope of the drainage facility and store the flood-related information in the storage unit 11 in real time.

The apparatus 10 for urban flood simulation may simulate the water outflow and drainage flow using the SWMM 400 and visualize the simulation results. The user may access the apparatus 10 for urban flood simulation using the web application installed on the terminal 20 and check the visualized simulation results. Through this, the user may receive the visualized simulation results from the apparatus 10 for urban flood simulation without a high-spec GUI (graphical user interface).

The flood information generation unit 13 may generate the ground surface outflow and drainage facility status information in real time according to the precipitation conditions based on the SWMM 400. The flood information generation unit 13 may receive various climate scenarios (precipitation patterns, or the like) from the user's terminal 20 and simulate the flood situation simultaneously. The user may monitor the flood situation by accessing the web page using the terminal 20.

Unlike conventional systems limited to local networks, the apparatus 10 for urban flood simulation according to the present disclosure may be designed so that multiple users may check and manage real-time flood situations even in external networks.

The apparatus 10 for urban flood simulation may automatically calculate whether each facility may additionally handle excess capacity when the precipitation increases during simulation based on the SWMM 400 and warn of flooding and/or backflow risks at each point.

According to one embodiment of the present disclosure, the storage unit 11 may store an artificial neural network model (hereinafter referred to as a “flow analysis model”) that generates water outflow quantity at the ground surface and discharge quantity information at each drainage facility using the simulation zone information, the water flow information, and the precipitation information as input values.

In the above Step S11-3, the flood information generation unit 13 inputs the simulation zone information, the water flow information, and the precipitation information to the flow analysis model 401, and may obtain the water outflow quantity at the ground surface and the discharge quantity information (hereinafter referred to as “flow prediction information”) at each drainage facility from the flow analysis model.

The flood information generation unit 13 may generate the flood-related information using flow prediction information 307 obtained from the flow analysis model 401.

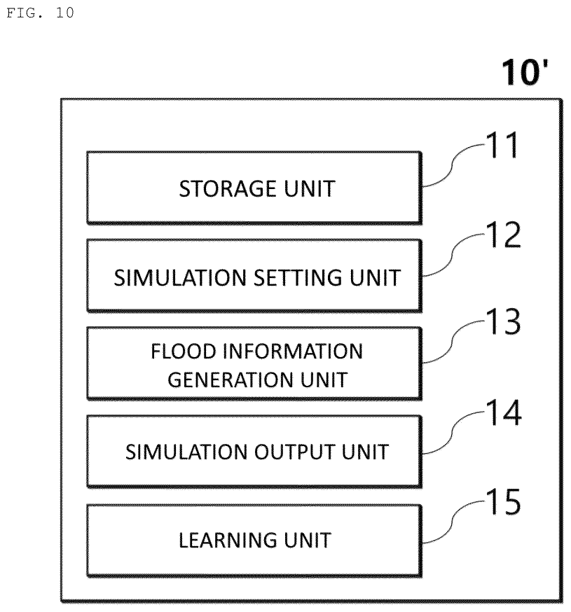

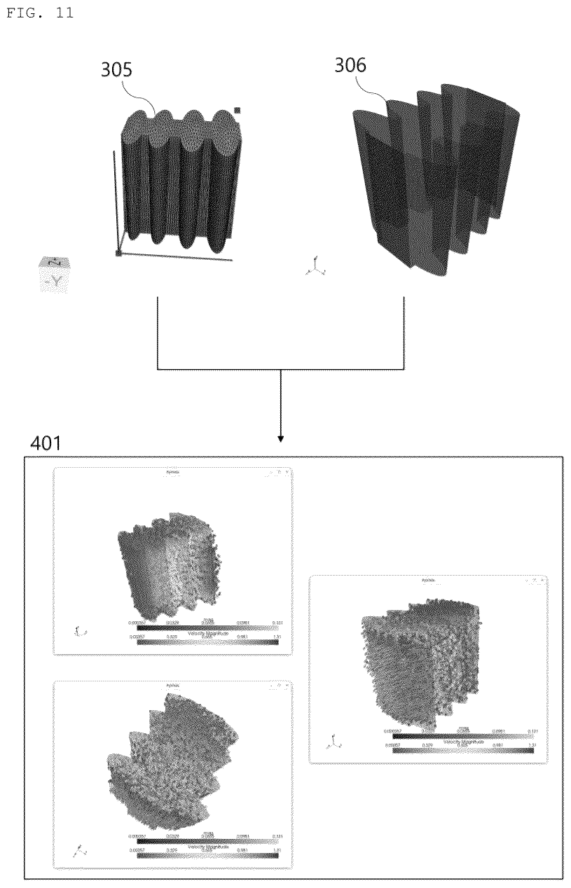

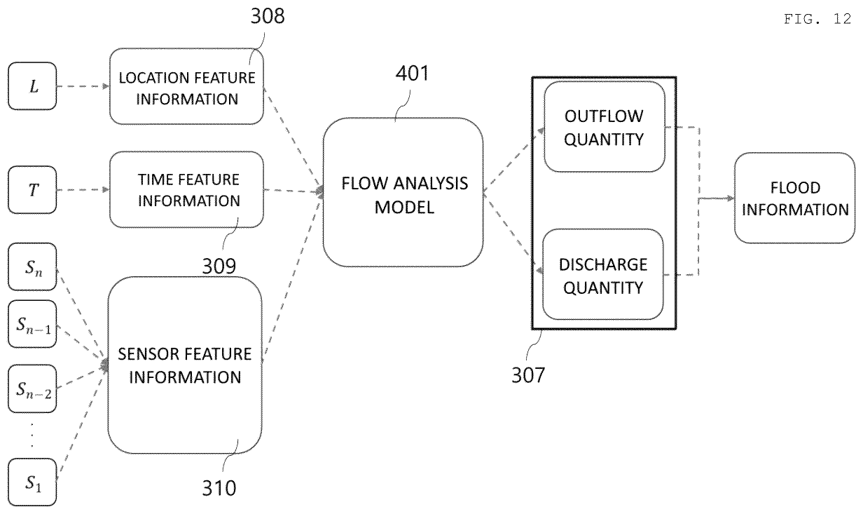

FIG. 10 is a block diagram of an apparatus for urban flood simulation according to another embodiment of the present disclosure, FIG. 11 illustrates a process of training a flow analysis model based on spatial information and physical conditions according to one embodiment of the present disclosure, and FIG. 12 illustrates a process of generating the flood-related information using the flow analysis model according to one embodiment of the present disclosure.

Referring to FIGS. 10 to 12, an apparatus 10′ for urban flood simulation according to another embodiment of the present disclosure may include a storage unit 11, a simulation setting unit 12, a flood information generation unit 13, a simulation output unit 14, and a learning unit 15. A repetitive description of the storage unit 11, the simulation setting unit 12, the flood information generation unit 13, and the simulation output unit 14 will be omitted.

The learning unit 15 may train the flow analysis model 401 using the 3D mesh data 305 of the city generated based on the digital elevation model 300 of the city and the city design information 301 as training data. The 3D mesh data 305 of the city may correspond to the simulation zone information. The flow analysis model 401 may train the spatial information on the simulation zone using the 3D mesh data 305 of the city.

The learning unit 15 may learn the flow analysis model 401 by using the simulation zone information, the water flow information, and the precipitation information according to a specific city as training data.

According to one embodiment of the present disclosure, the flow analysis model 401 may be a physics-informed neural network (PINN) model that integrates physical laws into the learning process. In this case, the flow analysis model 401 may correspond to a regression model.

The flow analysis model 401 may have boundary conditions and physical conditions set (306) during the learning process. The loss function of the flow analysis model 401 may include equations according to the boundary conditions and physical conditions.

Dirichlet boundary condition and Neumann boundary condition may be set as the boundary conditions. The Dirichlet boundary condition may be a boundary condition for analyzing the water level and velocity at each point. The Neumann boundary condition may be a boundary condition for analyzing the change in flow rate and velocity at each point.

The physical conditions may include at least one momentum equation by the Green-Ampt model and external forces (gravity, friction, resistance, or the like). The at least one momentum equation may include physical laws of fluid dynamics such as the Navier-Stokes equation and the law of conservation of momentum.

The process of setting boundary conditions and physical conditions in the physics-informed artificial neural network model is a widely known technique among those skilled in the art, so a detailed description thereof is omitted.

The above flow analysis model 401 may be trained to generate the outflow of water from the ground surface and the amount of water discharged from each drainage facility based on the simulation zone information, the water flow information, the precipitation information, the boundary conditions, and the physical conditions. The flow analysis model 401 may be trained to minimize the value of the loss function including the boundary conditions and the physical conditions. The flow analysis model 401 may be trained to receive the simulation zone information, the water flow information, and the precipitation information as training data and generate the flow prediction information 307 that minimizes the value of the loss function.

The flood information generation unit 13 may obtain the flow prediction information 307 in real time by using the flow analysis model 401. The flow analysis model 401 may generate the flow prediction information 307 through the physical laws and mathematical equations. In addition, the flow analysis model 401 may increase the data processing speed through parallel operation.

The flood information generation unit 13 may obtain the flow prediction information 307 at each point by using the information related to the precipitation, pipe size, and drainage path in real time using the flow analysis model 401.

The flow analysis model 401 may include essential equations of fluid dynamics such as the Navier-Stokes equation, the law of conservation of momentum, and the infiltration equation as a portion of the loss function. Through this, the flow analysis model 401 may generate the flow prediction information 307 in the city with only a small amount of data and parallel operations. The apparatus 10′ for urban flood simulation according to the present disclosure may efficiently generate complex water flow information in the city by utilizing the artificial neural network model based on such physical laws.

The above-mentioned flow analysis model 401 has the advantage of being able to generate complex physical flow pattern information with less data than the traditional computational fluid dynamics (CFD) method.

The traditional numerical analysis method divides a three-dimensional space into a plurality of small grids (mesh) to generate information related to the flow of water, and calculates physical variables (velocity, pressure, or the like of water) in each grid. In this case, the more complex the grid structure, the more data consumption increases. However, the above-mentioned flow analysis model 401 may generate physical flow pattern information in a mesh-free manner by including the boundary conditions and physical conditions in the loss function. In other words, the artificial neural network model based on physical laws may reduce the data consumption and computational amount for generating physical flow pattern information compared to the past because the artificial neural network model does not divide the three-dimensional space into grids, unlike the traditional numerical analysis method.

In addition, the traditional numerical analysis method calculates physical variables through a fixed computational process set in advance for each grid. In this case, the boundary conditions and physical conditions may be set independently for each grid. At this time, when the boundary conditions and physical conditions change, the manager should separately modify the boundary conditions and physical conditions for each grid. However, the flow analysis model 401 may include the boundary conditions and physical conditions as a loss function. When the boundary conditions and physical conditions change, the manager may respond more flexibly than before by modifying only the loss function of the flow analysis model 401.

The flood information generation unit 13 may obtain information such as flow velocity, pressure, and flow rate of each point in the city in real time using the flow analysis model 401. Through this, the apparatus 10 for urban flood simulation according to the present disclosure may generate the flow prediction information 307 in real time, which is difficult with the conventional method, and may send an early warning for an area with a high flood risk to the terminal 20.

The flow analysis model 401 may include the physical laws of fluid dynamics, such as the Navier-Stokes equation and the law of conservation of momentum, as a portion of the loss function.

$$ρ ( \frac{δ u}{δ t} + ( \vec{u} \cdot ∇ ) \vec{u} ) = - ∇ p + μ {∇}^{2} \vec{u} + f \qquad [ Mathematical Formula 9 ]$$

ρ: fluid density
\vec{u}: fluid velocity vector
p: fluid pressure
μ: fluid viscosity coefficient
f: external force

Based on this, the flow analysis model 401 may receive the simulation zone information, the water flow information, and the precipitation information and generate the flow prediction information 307 in real time. In this process, the flow analysis model 401 may calculate the water flow through physical laws and mathematical equations, and increase the data processing speed through parallel operation. The flow analysis model 401 may calculate the water flow in real time using information related to the precipitation, pipe size, and drainage path.

By utilizing the physics-informed artificial neural network model, water flow may be calculated based on physical laws, so that the flood risk may be predicted quickly and accurately. Unlike the conventional CFD method, the physics-informed artificial model network may generate neural information related to the water flow, flow velocity, and pressure distribution in real time by integrating physical laws into neural network learning. This prediction result may be used for immediate response and efficient response according to the precipitation.

The flood information generation unit 13 may extract a plurality of feature information from the simulation zone information, the water flow information, and the precipitation information. The feature information may include location feature information 308, time feature information 309, and sensor feature information 310.

The location feature information 308 may include content related to the location of each drainage facility. The time feature information 309 may include content related to the precipitation time, the time taken for water to be discharged from each drainage facility, the time taken for water to flow out of a watershed, or the like. The sensor feature information 310 may include content related to water resistance according to changes in flow due to the depth of a manhole, the length of a sewer (or drain pipe), a pipe elbow, or the like, precipitation, land use information, watershed characteristics information, infiltration amount into soil, or the like. In addition, all information related to the simulation zone information, the water flow information, the precipitation information, the precipitation pattern information, and the expected flood pattern information described above may be input into the flow analysis model 401.

According to one embodiment of the present disclosure, the flood information generation unit 13 may independently generate the flood-related information using the SWMM 400 and the flow analysis model 401. For example, the flood information generation unit 13 may generate water level information, or the like, at each manhole, sewer, or the like in the network of the drainage system using the SWMM 400. In addition, the flood information generation unit 13 may generate the flow prediction information in the network of the drainage system using the flow analysis model 401. The flood information generation unit 13 may generate the flood-related information using the information generated in the SWMM 400 and the flow prediction information generated in the flow analysis model 401. The flood information generation unit 13 may generate information on whether flooding has occurred at each point in the network of the drainage system, the expected flooding occurrence time, or the like, using the information generated in the SWMM 400 and the flow prediction information generated in the flow analysis model 401.

The flood information generation unit 13 may supplement and weight the flow prediction information using information generated from the SWMM 400.

For example, the flood information generation unit 13 may identify and remove outliers in the flow prediction information using information generated from the SWMM 400.

As another example, in the process of training the fluid analysis model 401, the learning unit 15 may train the fluid analysis model 401 by further utilizing the information generated from the SWMM 400. The flood information generation unit 13 may further input the information generated from the SWMM 400 into the fluid analysis model 401 to generate the flow prediction information. Thereafter, the flood information generation unit 13 may generate the flood-related information by using the information generated from the SWMM 400 and the flow prediction information.

Through this, the flood information generation unit 13 may generate more accurate flood-related information than before.

According to another embodiment of the present disclosure, the flood information generation unit 13 may input the flow prediction information 307 generated from the flow analysis model into the SWMM 400. Based on the flow prediction information 307, the SWMM 400 may generate a more accurate urban flood simulation result than before.

Referring again to FIGS. 6 and 7, in Step S12, the simulation output unit 14 may visualize and display the flood-related information in the simulation zone.

As illustrated in FIG. 4, the simulation output unit 14 may visualize the simulation results as a 3D model, and express the water accumulation and flow status in real time. The simulation output unit 14 may visually distinguish and display the flood risk zone, and may provide a warning in the form of color or graph when the water level reaches a dangerous level.

For example, as illustrated in (b) in FIG. 4, the simulation output unit 14 may display the flood risk zone in stages. In this case, the simulation output unit 14 may display the flood risk zone in stages from stage 0, which has the lowest flood risk, to stage 3, which has the highest flood risk. When water has accumulated to 0 to 25% of the manhole depth of the corresponding zone, the flood risk may correspond to a stage 0. When water has accumulated to 25 to 50% of the manhole depth of the corresponding zone, the flood risk may correspond to a stage 1. When water has accumulated to 50 to 75% of the manhole depth of the corresponding zone, the flood risk may correspond to a stage 2. When water has accumulated to 75 to 100% of the manhole depth of the corresponding zone, the flood risk may correspond to a stage 3. When the flood risk is the stage 0, the simulation output unit 14 may not display a warning sign at the corresponding point. When the flood risk is the stage 1, the simulation output unit 14 may display a green warning sign 203 at the corresponding point. When the flood risk is the stage 2, the simulation output unit 14 may display a yellow warning sign 204 at the corresponding point. When the flood risk is the stage 3, the simulation output unit 14 may display a red warning sign 205 at the corresponding point. The above-mentioned flood risk criteria and methods for displaying the flood risk are examples and are not limited thereto.

The simulation output unit 14 may load the simulation results of each point from the storage unit 11 and configure a 3D environment that is automatically updated.

The simulation output unit 14 may visualize the simulation results in a 3D environment so that the user may intuitively understand the simulation results through the terminal 20 and quickly respond to flooding. The simulation output unit 14 may provide a warning notification when the flood risk increases in a specific zone by visualizing the status of each drainage facility and the amount of ground surface runoff. Unlike the conventional 2D-based visualization, the apparatuses 10 and 10′ for urban flood simulation according to the present disclosure may support intuitive monitoring for the user by expressing the flow and accumulation status of water at each point in the city in three dimensions. The user may check the warning in real time by using the web application of the terminal 20 and immediately take response measures for the risk zone.

The simulation output unit 14 may classify the point as the flood risk zone and send a warning to the terminal 20 when the amount of water accumulated at each point exceeds a certain threshold W_{threshold}. The simulation output unit 14 may monitor data at all points in real time and may display the corresponding information on a web-based dashboard when a warning occurs. The simulation output unit 14 may classify the point i as the flood risk zone and generate the warning notification when Wᵢ(t)>W_{threshold}.

Flood risk prediction is an essential function that allows users to recognize and respond to high flooding potential in advance. The apparatuses 10 and 10′ for urban flood simulation according to the present disclosure may automatically identify risk zones and provide immediate visual warnings. Through this, users may receive real-time notifications of risk zones through a web-based dashboard and intuitively grasp the risk level of each point.

The method for urban flood simulation according to an embodiment of the present disclosure may be implemented in the form of a computer program written to perform each step on a computer and recorded on a computer-readable recording medium. The above-mentioned computer program may include codes coded in a computer language, such as C/C++, C#, JAVA, Python, or machine language, that may be read by the processor (CPU) of the computer through the device interface of the computer, so that the computer reads the program and executes the methods implemented as the program. Such codes may include functional codes related to functions that define functions necessary for executing the methods, and may include control codes related to execution procedures necessary for the processor of the computer to execute the functions according to a predetermined procedure. In addition, such codes may further include memory reference-related codes regarding which location (address number) of the internal or external memory of the computer should be referenced for additional information or media necessary for the processor of the computer to execute the functions. In addition, when the processor of the computer needs to communicate with another computer or server located remotely in order to execute the functions, the code may further include communication-related codes regarding how to communicate with another computer or server located remotely using the communication module of the computer, what information or media to send and receive during communication, or the like.

The above storage medium means a medium that stores data semi-permanently and may be read by a device, rather than a medium that stores data for a short period of time, such as a register, cache, or memory. Specifically, examples of the storage medium include, but are not limited to, ROM, RAM, CD-ROM, magnetic tape, floppy disk, or optical data storage device. That is, the program may be stored in various storage media on various servers that the computer may access or in various storage media on the user's computer. In addition, the medium may be distributed to computer systems connected to a network, so that a computer-readable code may be stored in a distributed manner.

While the present disclosure has been described with reference to the attached drawings, it will be understood by those skilled in the art that the present disclosure may be implemented in other specific forms without altering the technical spirit or essential features thereof. Therefore, it should be understood that the embodiments described above are illustrative in all respects and not restrictive.

What is claimed is:

1. An apparatus for urban flood simulation, the apparatus comprising:
a storage unit configured to store a digital elevation model of a city, city design information and precipitation information, and at least one computer program configured to perform a method for urban flood simulation;
a simulation setting unit configured to generate simulation zone information and water flow information using the digital elevation model of the city and the city design information;
a flood information generation unit configured to generate flood-related information using the simulation zone information, the water flow information, and the precipitation information; and
a simulation output unit configured to visualize and display the flood-related information.

2. The apparatus according to claim 1, wherein the simulation setting unit generates connection relationship information of elements constituting at least one drainage facility and location information of each drainage facility using the digital elevation model of the city and the city design information.

3. The apparatus according to claim 2, wherein the simulation setting unit calculates a slope of a ground surface using an elevation value of the city extracted from the digital elevation model and generates information on a direction of water flow using the slope of the ground surface.

4. The apparatus according to claim 3, wherein the simulation setting unit further extracts an angle value of a pipe installed in the at least one drainage facility from the city design information, and calculates a degree (Fᵢⱼ) of water flowing to an adjacent point using the following Mathematical Formula:
$${F}_{ij} = \frac{( {H}_{i} - {H}_{j} )}{{d}_{ij}} \times P \times cos ( θ ) \qquad [ Mathematical Formula ]$$
Hᵢ: elevation at point i
Hⱼ: elevation at point j
dᵢⱼ: distance between two points
P: drainage characteristic coefficient
θ: pipe angle.

5. The apparatus according to claim 2, wherein the simulation setting unit calculates a discharge capacity (Dₒᵤₜ) water in the at least one drainage facility using the following Mathematical Formula using information on the pipe installed in the at least one drainage facility from the city design information:
$${D}_{out} = {D}_{m} \times ( 1 - α \frac{{R}_{p}}{{W}_{p}} ) \qquad [ Mathematical Formula ]$$
Dₘ: basic discharge capacity of drainage facility
α: friction coefficient inside pipe
Rₚ: number of turns of pipe
Wₚ: width of pipe.

6. The apparatus according to claim 1, wherein the flood information generation unit generates information related to an expected flood pattern according to at least one precipitation pattern using the simulation zone information, the water flow information, and the precipitation information, and generates the flood-related information by further using the information related to the expected flood pattern.

7. The apparatus according to claim 6, wherein the simulation zone information further includes content related to watershed characteristics of the city,
the content related to the watershed characteristics of the city includes at least one of an infiltration rate of water into soil, outflow of water from the ground surface per unit time, and a time taken for water to reach an outflow point, and
the flood information generation unit generates the information related to the expected flood pattern by further using the content related to the watershed characteristics.

8. The apparatus according to claim 1, wherein the storage unit further stores an artificial neural network model that generates water outflow quantity and water discharge quantity information of at least one drainage facility using the simulation zone information, the water flow information, and the precipitation information as input values, and
the flood information generation unit inputs the simulation zone information, the water flow information, and the precipitation information to the artificial neural network model, and obtains the water outflow quantity and the water discharge quantity of the at least one drainage facility from the artificial neural network model to generate the flood-related information.

9. The apparatus according to claim 8, wherein the artificial neural network model includes a Navier-Stokes equation expressed by the following Mathematical Formula as a portion of a loss function:
$$ρ ( \frac{δ u}{δ t} + ( \vec{u} \cdot ∇ ) \vec{u} ) = - ∇ p + μ {∇}^{2} \vec{u} + f \qquad [ Mathematical Formula ]$$
ρ: fluid density
\vec{u}: fluid velocity vector
p: fluid pressure
μ: fluid viscosity coefficient
f: external force.

10. The apparatus according to claim 1, wherein when an amount of water accumulated at at least one point included in the simulation zone exceeds a preset threshold, the simulation output unit sets the point as a flood risk zone and displays a degree of flood risk in stages according to the amount of water accumulated.

11. A method for urban flood simulation in an apparatus for urban flood simulation including a hardware processor and a storage unit connected to the processor to store a digital elevation model of a city, city design information and precipitation information, and at least one computer program configured to perform the method for urban flood simulation, the method comprising:
(a) generating simulation zone information and water flow information using the digital elevation model of the city and the city design information;
(b) generating flood-related information using the simulation zone information, the water flow information, and the precipitation information; and
(c) visualizing and displaying the flood-related information.

12. The method according to claim 11, wherein the (a) includes generating connection relationship information of elements constituting at least one drainage facility and location information of each drainage facility using the digital elevation model of the city and the city design information.

13. The method according to claim 12, wherein the (a) includes calculating a slope of a ground surface using an elevation value of the city extracted from the digital elevation model and generating information on a direction of water flow using the slope of the ground surface.

14. The method according to claim 13, wherein the (a) further includes extracting an angle value of a pipe installed in the at least one drainage facility from the city design information, and calculating a degree (Fᵢⱼ) of water flowing to an adjacent point using the following Mathematical Formula:
$${F}_{ij} = \frac{( {H}_{i} - {H}_{j} )}{{d}_{ij}} \times P \times cos ( θ ) \qquad [ Mathematical Formula ]$$
Hᵢ: elevation at point i
Hⱼ: elevation at point j
dᵢⱼ: distance between two points
P: drainage characteristic coefficient
θ: pipe angle.

15. The method according to claim 12, wherein the (a) includes calculating a discharge capacity (Dₒᵤₜ) of water in the at least one drainage facility using the following Mathematical Formula using information on a pipe installed in the at least one drainage facility from the city design information:
$${D}_{out} = {D}_{m} \times ( 1 - α \frac{{R}_{p}}{{W}_{p}} ) \qquad [ Mathematical Formula ]$$
Dₘ: basic discharge capacity of drainage facility
α: friction coefficient inside pipe
Rₚ: number of turns of pipe
Wₚ: width of pipe.

16. The method according to claim 11, wherein the (b) is generating information related to an expected flood pattern according to at least one precipitation pattern using the simulation zone information, the water flow information, and the precipitation information, and generating the flood-related information by further using the information related to the expected flood pattern.

17. The method according to claim 16, wherein the simulation zone information further includes content related to watershed characteristics of the city,
the content related to the watershed characteristics of the city includes at least one of an infiltration rate of water into soil, outflow of water from a ground surface per unit time, and a time taken for water to reach an outflow point, and
the (b) is generating the information related to the expected flood pattern by further using the content related to the watershed characteristics.

18. The method according to claim 11, wherein the storage unit further stores an artificial neural network model that generates water outflow quantity and water discharge quantity information of at least one drainage facility using the simulation zone information, the water flow information, and the precipitation information as input values, and
the (b) is inputting the simulation zone information, the water flow information, and the precipitation information to the artificial neural network model, and obtaining the water outflow quantity and the water discharge quantity of the at least one drainage facility from the artificial neural network model to generate the flood-related information.

19. The method according to claim 18, wherein the artificial neural network model includes a Navier-Stokes equation expressed by the following Mathematical Formula as a portion of a loss function:
$$ρ ( \frac{δ u}{δ t} + ( \vec{u} \cdot ∇ ) \vec{u} ) = - ∇ p + μ {∇}^{2} \vec{u} + f \qquad [ Mathematical Formula ]$$
ρ: fluid density
\vec{u}: fluid velocity vector
p: fluid pressure
μ: fluid viscosity coefficient
f: external force.

20. The method according to claim 11, wherein the (c) includes, when an amount of water accumulated at at least one point included in the simulation zone exceeds a preset threshold, setting the point as a flood risk zone and visualizing a degree of flood risk in stages according to the amount of water accumulated.

21. A computer program written to perform each step of the method for urban flood simulation according to claim 11 on a computer and recorded on a computer-readable recording medium.
